(19) United States
(12) Patent Application Publication
(10) Pub. No.: US 2020/0340180 A1
(43) Pub. Date: Oct. 29, 2020

(54) THREE-DIMENSIONAL PAPERMAKING BELT

(71) Applicant: Kimberly-Clark Worldwide, Inc., Neenah, WI (US)

(72) Inventors: Mark Alan Burazin, Oshkosh, WI (US); Geoffrey Fenn Carlow, Neenah, WI (US); Lynda Ellen Collins, Neenah, WI (US); Robert Eugene Krautkramer, Combined Locks, WI (US)

(21) Appl. No.: 16/958,912

(22) PCT Filed: Dec. 28, 2018
(86) PCT No.: PCT/US18/67958

§ 371 Date: Jun. 29, 2020

Related U.S. Application Data
(60) Provisional application No. 62/611,591, filed on Dec. 29, 2017.

(51) Int. Cl. D21F 7/08; B33Y 80/00; B33Y 70/00; B33Y 10/00; B29C 64/10; D21H 27/00; D21H 27/02; D21F 11/00; B65G 15/42

(52) U.S. Cl. CPC D21F 7/08; B33Y 80/00; B33Y 70/00; B33Y 10/00; B29L 2031/7092; D21H 27/002; D21H 27/02; D21F 11/006; B65G 15/42; B29C 64/10

(57) ABSTRACT

Provided are papermaking belts comprising a plurality of 3-D printed modules comprising first and second machine direction extending arms that may be interdigitated with one another and joined by a linkage pin. The 3-D printed modules generally have protuberances and apertures to facilitate molding and dewatering of the embryonic tissue web during manufacture. The protuberances are joined to, and extend from, the first web contacting surface of the module and are integrally formed therewith. In this manner the web contacting surface of the belt comprises a first and a second plane, where the second plane is generally defined by the upper surface plane of the protuberances. The apertures, which generally consist of both intra-module and inter-module apertures, allow water to be removed from a tissue web during manufacture.

### BACKGROUND

The present invention relates to improved fabrics used to manufacture tissue products, such as bath tissue, paper towels, napkins and the like having three dimension surface topography that result in visually discernable patterns, methods of tissue manufacture, and methods of fabric manufacture.

In the manufacture of tissue products, particularly absorbent tissue products, there is a continuing need to improve the physical properties and final product appearance. It is generally known in the manufacture of tissue products that there is an opportunity to mold a partially dewatered cellulosic web on a papermaking belt specifically designed to enhance the finished paper product's physical properties. Such molding can be applied by fabrics in an uncreped through-air dried process as disclosed in U.S. Pat. No. 5,672,248 or in a wet pressed tissue manufacturing process as disclosed U.S. Pat. No. 4,637,859. Wet molding typically imparts desirable physical properties independent of whether the tissue web is subsequently creped, or an uncreped tissue product is produced.

However, absorbent tissue products are frequently embossed in a subsequent operation after their manufacture on the paper machine, while the dried tissue web has a low moisture content, to impart consumer preferred visually appealing textures or decorative lines. Thus, absorbent tissue products having both desirable physical properties and pleasing visual appearances often require two manufacturing steps on two separate machines. Hence, there is a need for a single step paper manufacturing process that can provide the desired visual appearance and product properties. There is also a need to develop a paper manufacturing process that not only imparts visually discernable pattern and product properties, but which does not affect machine efficiency and productivity.

Previous attempts to combine the above needs, such as those disclosed in International Application Nos. PCT/US13/72220, PCT/US13/72231 and PCT/US13/72238 have utilized through-air drying fabrics having a pattern extruded as a line element onto the fabric. The extruded line element may form either discrete or continuous patterns. While such a method can produce textures, extrusion techniques are limited in the types of lines that may be formed resulting in reduced permeability of the through-air drying fabric. The reduced permeability in-turn decreases drying efficiency and negatively affects tissue machine efficiency and productivity.

As such, there remains a need for papermaking belts useful in the manufacture of, and methods of producing tissue products having, visually discernable patterns with improved physical properties without losses to tissue machine efficiency and productivity.

### SUMMARY

The present invention provides a papermaking belt comprising a plurality of discrete modules joined together with linkage pins. The discrete modules are joined so as to extend in both the machine and cross-machine direction of the resulting papermaking belt and to form a belt having a plurality of apertures through which water and air may flow and a plurality of spaced apart protuberances that provide the sheet contacting surface of the belt with a three-dimensional topography. Together the apertures and protuberances provide a papermaking belt that balances permeability and topography and overcomes many limitations of prior art papermaking belts. For example, a papermaking belt of the present invention may be used as a through-air drying fabric in a tissue making process to produce a tissue web having a substantially uniform density as well as optionally possessing visually discernible decorative elements while providing a porous fabric that does not impede through-air drying of the tissue web.

Preferably the individual modules that make up the papermaking belt are manufactured using 3-D printing techniques known in the art such as continuous liquid interphase printing (CLIP), fused deposition modeling (FDM), electron-beam freeform fabrication (EBF3), direct metal laser sintering (DMLS), electron-beam melting (EBM), selective laser sintering (SLS), selective heat sintering (SHS), laminated object manufacturing (LOM), stereolithography (SLA), digital light processing (DLP), multi-jet modeling (MJM), and the like. Thus, in certain preferred embodiments, the discrete modules are unitary and made entirely of the same materials, which enables the belt to be constructed without a support structure, such as a woven support structure, as is common in the prior art. In this manner the papermaking belt of the present invention may comprise a plurality of discrete unitary modules manufactured by 3-D printing and comprise cyanate ester, isocyanate, benzoxazine, polyimide, Phthalonitrile resin (PN), bismaleimide, silicone resin, and mixtures thereof, wherein the modules are interconnected by a linkage pin to form the belt. In other instances belts may be impregnated with conductive materials, such as metallic particles, to increase their thermal conductivity and reduce their emissivity.

To improve the efficiency and effectiveness of papermaking belts prepared according to the present invention, particularly when the belts are used as through-air drying belts, the air permeability of the belt may be increased by manufacturing the belt with a high degree of open area, such as a belt having a plurality of apertures and having an open area greater than about 10 percent and more preferably greater than about 20 percent. The apertures are preferably formed both within the modules themselves, referred to as intra-module apertures, and between interdigitated modules, referred to as inter-module apertures.

In addition to having a relatively high degree of open area, belts of the present invention may have a high degree of air permeability, such as an air permeability greater than about 300 CFM and more preferably greater than about 500 CFM, such as from about 300 to about 1400 CFM and more preferably from about 500 to about 700 CFM.

In other embodiments the present invention provides a papermaking belt consisting essentially of a plurality of identical modules interconnected by a cross-machine direction extending linkage pin. To facilitate interconnection of adjacent links into a useful papermaking belt each module may include linking ends pivotally connected to the linking ends of an adjacent module by a linkage pin for relative pivotal movement of adjacent modules about a first axis, which is generally orthogonal to the machine direction axis of the belt. The linkage of discrete modules in this manner creates a belt that is capable of movement in a straight path along the machine direction and a curved path in a plane transverse to the machine direction. Thus, the belt may be used to convey a web in the machine direction and pivot about an axis orthogonal to the machine direction to allow the belt to travel over and around machinery employed in a typical papermaking operation such as vacuum pickup shoes, rollers, and drying cylinders.

In another embodiment the present invention provides a papermaking belt having a machine and a cross-machine direction, a web contacting surface and a machine contacting surface, the belt comprising a plurality of discrete modules extending in the machine and cross-machine direction, the modules comprising a central portion, a first pair of arms extending in a first direction and a second pair of arms extending in a second direction, two or more spaced apart protuberances that form a portion of the web contacting surface of the belt disposed on the first or second pair of arms, and a plurality of apertures disposed along the central portion and extending from the web contacting surface of the web to the machine contacting surface of the fabric, the first pair of arms of a first module interdigitated with the second pair of arms of an adjacent second module and a linkage pin extending in the cross-machine direction through the interdigitated first and second arms to join the first and second modules together.

In other embodiments the present invention provides a method of manufacturing a papermaking belt by solid freeform fabrication (SFF). Solid freeform fabrication may be used to form a discrete module layer by layer, in a stepwise fashion, out of a flowable material that is subsequently solidified so as to withstand the rigors of the papermaking process, such as high temperatures and humidity. The SFF manufactured discrete modules comprise a central portion, a first pair of arms extending in a first direction and a second pair of arms extending in a second direction, two or more spaced apart protuberances disposed on the first or second pair of arms and defining a portion of the web contacting surface of the belt, and a plurality of apertures disposed along the central portion and extending from a first surface of the module to a second surface of the module.

In yet other embodiments the present invention provides a process for constructing an apertured papermaking belt having a machine direction, a cross-machine direction, a web contacting surface and a machine contacting surface comprising the steps of: dispensing a flowable material from an extrusion head, the material selected from the group consisting of cyanate ester, isocyanate, benzoxazine, polyimide, Phthalonitrile resin (PN), bismaleimide, silicone resin, and mixtures thereof; transporting the extrusion head in the x, y and z-directions while discharging the flowable material from a discrete module having a central portion, a first pair of arms extending in a first direction and a second pair of arms extending in a second direction, the central portion comprising a plurality of apertures extending in the z-direction from a first side of the central portion to a second side of the central portion, the first pair of arms comprising a first transverse extending aperture and the second pair of arms comprising a second transverse extending aperture, interdigitating the first pair of arms of a first module with a second pair of arms of an adjacent second module and disposing a linkage pin in the transverse extending apertures of the interdigitated first and second arms to join the first and second modules together.

These and other aspects of the invention will now be more fully described with reference to the drawings.

### DESCRIPTION OF THE DRAWINGS

FIG. 1 illustrates a top view of a discrete module according to one embodiment of the present invention;

FIG. 2 illustrates a cross-sectional view of the discrete module of FIG. 1 through the line FIG. 2-FIG. 2;

FIG. 3 illustrates a perspective view of a discrete module according to one embodiment of the present invention;

FIG. 4 illustrates a top view of a portion of a papermaking belt according to one embodiment of the present invention;

FIG. 5 illustrates a perspective view of a portion of a papermaking belt according to one embodiment of the present disclosure;

FIG. 6 illustrates a top view of a portion of a papermaking belt according to another embodiment of the present invention;

FIG. 7 illustrates a cross-sectional view of a pair of connected modules useful in the manufacture of a papermaking belt according to the present invention;

FIG. 8 is a digital image of the web contacting surface of a portion of a belt prepared according to the present invention, the image was taken using a VHX-1000 Digital Microscope manufactured by Keyence Corporation of Osaka, Japan at a magnification of 200×; and

FIG. 9 is a three-dimensional image of the belt of FIG. 8 taken using a Keyence VHX-1000 Digital Microscope.

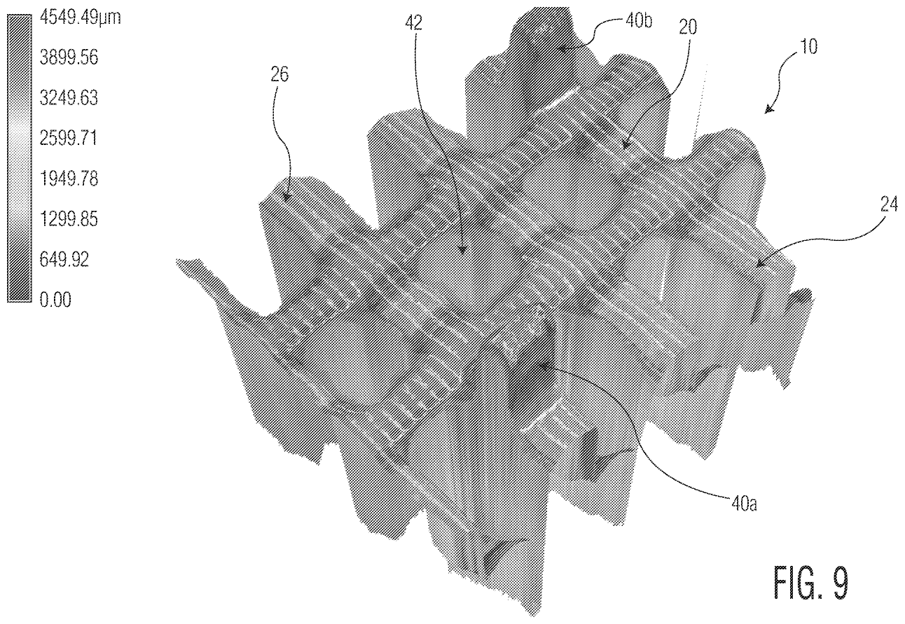

### DEFINITIONS

As used herein the term “Air Permeability” refers to the relative amount of air that may pass through a papermaking fabric. Air permeability may be measured with the FX 3300 Air Permeability device manufactured by Textest AG (Zurich, Switzerland), set to a pressure of 125 Pa with the normal 7-cm diameter opening (38 square centimeters area), which gives readings of Air Permeability in cubic feet per minute (CFM) that are comparable to well-known Frazier Air Permeability measurements. The Air Permeability value for the tissue making fabrics useful in the present invention may be about 30 CFM or greater, such as any of the following values (about or greater): 50 CFM, 70 CFM, 100 CFM, 150 CFM, 200 CFM, 250 CFM, 300 CFM, 350 CFM, 400 CFM, 450 CFM, 500 CFM, 550 CFM, 600 CFM, 650 CFM, 700 CFM, 750 CFM, 800 CFM, 900 CFM, 1000 CFM, and 1100 CFM. Exemplary ranges include from about 200 to about 1400 CFM, from about 300 to about 1200 CFM, and from about 100 to about 800 CFM. For some applications, low Air Permeability may be desirable. Thus, the Air Permeability of the tissue making fabric may be about 500 CFM or less, about 400 CFM or less, about 300 CFM or less, or about 200 CFM or less, such as from about 30 CFM to about 150 CFM.

As used herein, the term “tissue product” refers to products made from tissue webs and includes bath tissues, facial tissues, paper towels, industrial wipers, foodservice wipers, napkins, medical pads, and other similar products. Tissue products may comprise one, two, three or more plies.

As used herein, the terms “tissue web” and “tissue sheet” refer to a fibrous sheet material suitable for forming a tissue product.

As used herein, the term “module” refers to a discrete unit that may be combined with other discrete units to form a papermaking belt according to the present invention.

As used herein the term “protuberance” refers to separate, unconnected elements forming a portion of the web contacting surface of a papermaking belt according to the present invention. Generally a protuberance is integrally formed with a module and extends in the z-direction above a first web contacting plane of the module. In use a protuberance may contact and mold the nascent web as it is supported and transported by a papermaking belt according to the present invention. The belt may comprise a plurality of protuberances disposed on two or more discrete modules and arranged so as to form a decorative pattern. Protuberances may have any number of cross-sectional shapes such as round, oval, triangular, square, rectangular, pentagonal, hexagonal, octagonal, and the like.

As used herein the term “line element” refers to an element in the shape of a line, which may be a continuous, discrete, interrupted, and/or partial line with respect to a support structure on which it is present. The line element may be of any suitable shape such as straight, bent, kinked, curled, curvilinear, serpentine, sinusoidal, and mixtures thereof.

As used herein the term “continuous line element” refers to a line element disposed on the web contacting surface of a papermaking belt according to the present invention that extends without interruption throughout one dimension of the belt.

As used herein the term “curvilinear decorative element” refers to any line or visible pattern that contains either straight sections, curved sections, or both that are substantially connected visually. Curvilinear decorative elements may appear as undulating lines, substantially connected visually, forming signatures or patterns.

As used herein the term “decorative pattern” refers to any non-random repeating design, figure, or motif. It is not necessary that the curvilinear decorative elements form recognizable shapes, and a repeating design of the curvilinear decorative elements is considered to constitute a decorative pattern.

As used herein the term “aperture” refers to an opening extending from the web contacting surface of a papermaking belt according to the present invention to the machine contacting surface of the belt. An aperture generally comprises a first hole disposed on the web contacting surface and a second hold disposed on the machine contacting layer where the holes are joined by a continuous channel.

### DETAILED DESCRIPTION

The present inventors have now surprisingly discovered that 3-D printing techniques may be used to produce novel paper machine clothing useful in the manufacture of paper webs and more particularly tissue webs. In particular the present inventors have discovered that 3-D printing may be used to fabricate three-dimensional discrete modules having protuberances and apertures that may be combined with one another to produce a belt useful in the production of tissue products. In certain instances the modules may be designed to yield tissue products having a substantially uniform density as well as visually discernible decorative patterns. Producing the discrete modules by 3-D printing provides the benefit of being able to form apertures on both the support structure and paper contacting surfaces of the elements and connecting the apertures with continuous channels. These continuous channels, which join the two surfaces of the module, such as the web contacting surface and the machine contacting surface, to facilitate removal of water from the wet paper web during production. Further, the modules may be provided with protuberances on their web contacting surface, which may impart the web with a three-dimensional pattern that is visually distinctive.

The papermaking belts of the present invention may be used as a through-air drying fabric for transporting an embryonic tissue web across drying cylinders during the tissue manufacturing process. In other embodiments, papermaking belts of the present invention may be used as a transfer fabric for transporting an embryonic tissue web from forming wires to a through-air drying fabric.

Generally the papermaking belt of the present invention comprises a plurality of discrete modules extending in the machine and cross-machine direction and joined with one another to form an endless belt having two principle dimensions—a machine direction (MD), which is the direction within the plane of the belt parallel to the principal direction of travel of the tissue web during manufacture and a cross-machine direction (CD), which is generally orthogonal to the machine direction.

The belt further comprises a pair of opposed major surfaces—a web contacting surface and an opposite machine contacting surface. Machinery employed in a typical papermaking operation is well known in the art and may include, for example, vacuum pickup shoes, rollers, and drying cylinders. In one embodiment the belt comprises a through-air drying fabric useful for transporting an embryonic tissue web across drying cylinders during the tissue manufacturing process. In such embodiments the web contacting surface supports the nascent tissue web, while the opposite surface, the machine contacting surface, contacts the through-air dryer.

Preferably the belt comprises a plurality of apertures extending from the web contacting surface to the machine contacting surface which make the belt permeable to air and liquids. The belt also comprises a plurality of protuberances extending from the web contacting surface. The protuberances are generally integrally formed with the module and extend in the z-direction away from the first surface plane of the module to form part of the web contacting surface of the belt. Generally the protuberances, like the module, are formed by 3-D printing during manufacture of the module.

Preferably the protuberances are joined to, and extend from, the first web contacting surface of the module and are integrally formed therewith and comprise the same material. In this manner the web contacting surface of the belt comprises a first and second plane, where the second plane is generally defined by the upper surface plane of the protuberances. The protuberances produce substantial projected areas when viewed in plan. The protuberances may mold and shape the embryonic web during the papermaking process. For example, the papermaking process may comprise transferring a partially dewatered web from a forming belt to the belt of the present invention and applying a fluid pressure differential, heating, impressing, drying, and cooling while the web is in association with the instant belt. In certain embodiments the projected area may be at least about 1 percent and more preferably at least about 3 percent and still more preferably at least about 4 percent, such as from about 1 to about 50 percent and more preferably from about 1 to about 30 percent and still more preferably from about 3 to about 25 percent and more preferably from about 4 to about 10 percent. Projected area may be measured using profilometry as described in the Test Methods section below.

In addition to protuberances the web-contacting surface preferably comprises a plurality of landing areas. The landing areas generally bound the protuberances and are coextensive with the top surface plane of the belt. Landing areas may include apertures, often formed within the module itself and referred to herein as intra-module apertures, which allow water to be removed from a supported web by the application of differential fluid pressure, by evaporative mechanisms, or both when drying air passes through the nascent web while on the papermaking belt or a vacuum is applied through the belt. Without being bound by any particularly theory, it is believed that the arrangement of elements and landing areas allow the molding of the nascent web causing fibers to deflect in the z-direction and generate the caliper of, and aesthetic patterns on, the resulting tissue web.

In addition to intra-module apertures, in certain instances, the belt may include apertures formed when two modules are interdigitated with one another to form a portion of the belt and the belt is placed under tension. These apertures, which are formed between adjacent linked modules are referred to herein as inter-module apertures. Together the intra-module and inter-module apertures may yield a belt having substantial projected open areas when the belt is viewed from the top. The projected open areas afford direct penetration of both air and water during the paper making process, such as during dewatering, drying and cleaning of the belt with showers. In certain embodiments the projected open area may be at least about 1 percent, such as from about 1 to about 50 percent and more preferably from about 3 to about 20 percent.

The projected open area may be varied to provide a belt having an air permeability from about 50 to about 1500 CFM. The degree of air permeability may depend on the intended use of the belt. For example, the belt may be used as a through-air drying (TAD) fabric and be designed to have a relatively high degree of air permeability, such as an air permeability greater than about 300 CFM and more preferably greater than about 500 CFM, such as from about 300 to about 1400 CFM and more preferably from about 500 to about 700 CFM.

Generally the novel belts of the present invention comprise a plurality of discrete modules. Discrete modules, which are preferably formed by 3-D printing, are joined together with other discrete modules to form a belt according to the present invention. The discrete modules forming the belt may, in certain embodiments, be identically shaped modules, while in other embodiments the modules may have different shapes. Regardless of whether the modules are substantially identically shaped or differently shaped, the resulting papermaking belt generally comprises a plurality of modules joined together by interdigitated arms having a linkage pin extending transversely therethrough. The papermaking belt can include a first longitudinal end and a second longitudinal end that can be joined together by interdigitating the arms of the respective modules forming the ends and inserting a linkage pin therethrough.

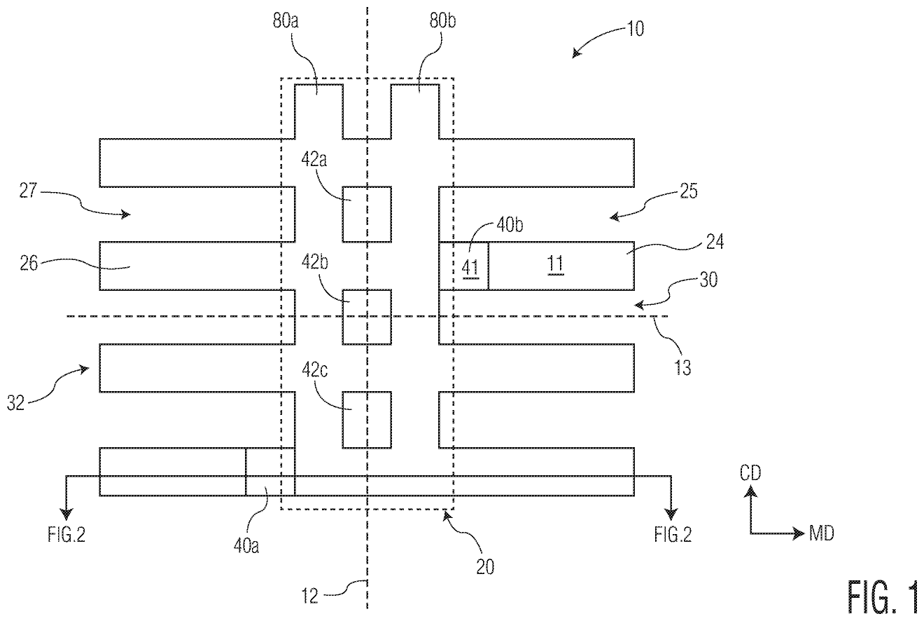

With reference now to FIG. 1, one embodiment of a module 10 according to the present invention is illustrated. The module 10 comprises a first surface 11 and an opposite second surface (not illustrated in FIG. 1). When several modules are joined to form a belt, the first side may form the web contacting surface of the resulting papermaking belt and the second surface may form the machine contacting surface. The second surface may be substantially planar and devoid of protuberances to facilitate travel over machinery employed in a typical papermaking operation such as, vacuum pickup shoes, rollers, and drying cylinders.

With continued reference to FIG. 1, the central portion 20 comprises a plurality of outwardly extending arms 24, 26. The arms 24, 26 extend in opposite directions from central portion 20 along a first axis 13 that is generally parallel to the machine direction (MD) of the resulting belt. In the illustrated embodiment the module 10 comprises four arms 24 extending in a first direction and four arms 26 extending in an opposite direction. Individual arms 24, 26 are spaced apart from one another in the cross-machine direction (CD) and define openings 25, 27 there between. While the module is illustrated as comprising four oppositely extending first and second sets of arms, the invention is not so limited and the number of arms may vary depending on the width of the module, the width of the arms, and the desired properties of the resulting belt. Generally the opposite extending sets of arms each comprise at least two individual arms.

The individual arms 24, 26 may be arranged parallel and the ends of the arms may define first and second ends 30, 32 of the module 10. In addition to opposite extending first and second sets of arms 24, 26 the module 10 may also be provided with end bars 80a, 80b. The end bars may be designed such that when the modules are joined together and extend in the cross-machine direction the resulting inter-module apertures are substantially similar in size to the intra-module apertures to provide the belt with relatively uniform permeability.

To join discrete modules together and form the papermaking belt, the arms of a first module may be interdigitated with the arms of a second module by inserting the arms of the first module into the spaces between the arms of the second module. Modules may be arranged adjacent to one another to form a belt having a plurality of modules extending in the cross-machine direction and the interdigitating of the arms of a first module with the arms of a second module may be repeated such that a plurality of modules extend in the machine direction.

With continued reference to FIG. 1, in certain embodiments, a module 10 may have a plane of symmetry about a central axis 12 extending generally parallel to the cross-machine direction axis of the belt. The central axis 12 divides the module 10 into first and second halves, each half having a plurality of opposite extending arms 24, 26, such as two, three, four, five or six or more arms extending in opposite directions. While the module 10 of FIG. 1 is symmetrical about the central axis 12, the invention is not so limited, and the modules may by asymmetrical. For example, in certain embodiments the modules may not have an equal number of opposite extending arms or the arms may not have equal widths or lengths.

The first side 11 of the module 10 generally comprises a plurality of protuberances—two illustrated in FIGS. 1, 40a and 40b. The protuberances 40 are generally disposed on the first side 11 such that the web-contacting surface of the resulting papermaking belt comprises a plurality of protuberances for cooperating with, and structuring of, the wet fibrous web during manufacturing. In a particularly preferred embodiment the web contacting surface of the resulting belt comprises a plurality of spaced apart three-dimensional protuberances distributed across the web-contacting surface and together constituting from at least about 15 percent of the web-contacting surface, such as from about 15 to about 35 percent, more preferably from about 18 to about 30 percent, and still more preferably from about 20 to about 25 percent of the web-contacting surface.

With further reference to FIG. 1, the module 10 further comprises a plurality of apertures 42a, 42b, 42c disposed along the central portion 20 of the module 10. The apertures may have a rectangular horizontal cross-sectional shape and join the first surface 11 with the opposite second surface (not illustrated in FIG. 1). While the module of FIG. 1 is illustrated as having three apertures disposed substantially along the central portion, the invention is not so limited and the number of apertures and their position on the module may be varied to provide the belt with a desired permeability. For example, a module may comprise one, two, three, four or five apertures. In a particularly preferred embodiment the apertures are disposed along the central portion and generally aligned with one another along the central axis of the module.

Generally an aperture comprises a first opening, also referred to herein simply as a hole, disposed on the web contacting surface and a second opening disposed on the machine contacting surface and a continuous channel joining the two. The continuous channel generally extends through the module in the z-direction creating a continuous passageway between the first and second contacting surfaces. Preferably the continuous channel is shaped so as to permit the passage of air and/or water through the element. In certain embodiments the channel may have a horizontal cross-section that is essentially circular, oval, triangular, square, rectangular, pentagonal, or hexagonal. The holes may have similar or different horizontal cross-sections relative to one another and the channel that joins them. In the embodiment illustrated in FIG. 1 all of the apertures 42a, 42b, 42c comprise holes and channels that are similarly shaped and have a rectangular horizontal cross-section.

Just as the horizontal cross-sectional shape of the aperture may vary, the size of the apertures may be varied to achieve the desired web dewatering and drying properties as well as the aesthetics of the resulting web. For example, by suitable choice of aperture dimensions and shape, the degree of visibility of the aperture pattern in the resulting tissue may be made as faint or as distinct as desired. Accordingly, in certain embodiments, the holes on the machine or web contacting surface of the belt, and forming part of the aperture, may have an area greater than about 0.20 mm², such as from about 0.20 to about 3.0 mm², and more preferably from about 0.40 to about 2.0 mm² and still more preferably from about 0.50 to about 1.50 mm² and even more preferably from about 0.60 to about 1.00 mm².

In other embodiments, where the holes and channels are substantially similar in size and shape, such as having a substantially rectangular horizontal cross-section, the width (w) may be about 0.10 mm or greater, such as from about 0.10 to about 3.0 mm and more preferably from about 0.50 to about 2.0 mm and still more preferably from about 0.75 to about 1.5 mm. The length of the channel may vary as it may take a variety of paths to connect a pair of opposed apertures, however in a preferred embodiment the channel is substantially linear and has a length that is essentially the same as the height of the central portion of the module.

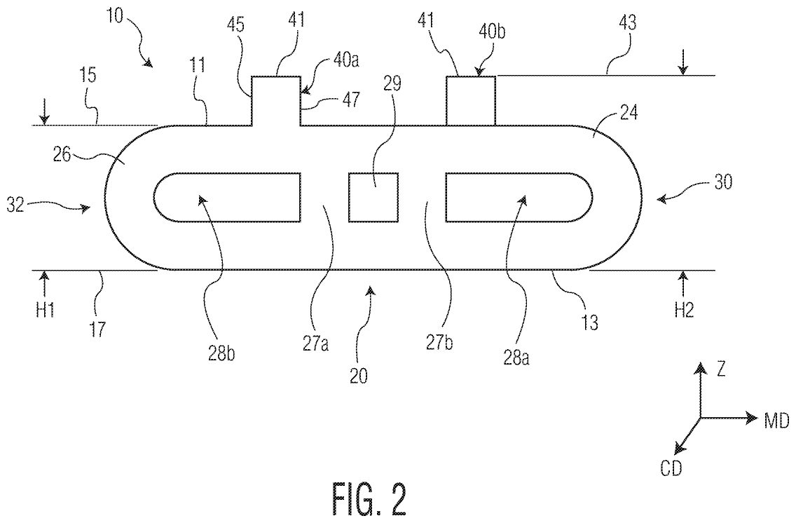

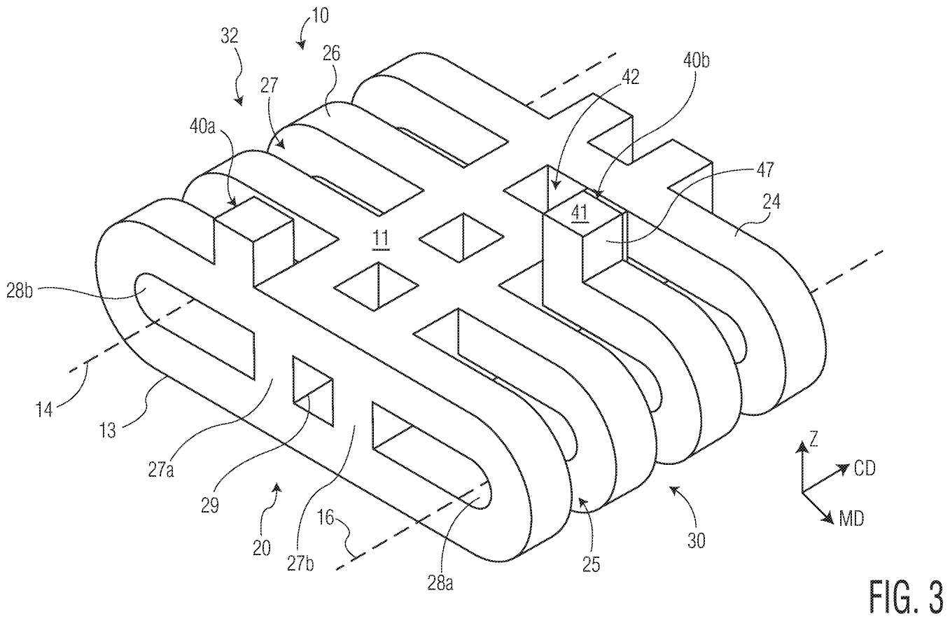

With reference now to FIGS. 2 and 3, the module 10 comprises a central portion 20 and opposite extending arms 24, 26 that terminate to define first and second module ends 30, 32. The upper surface of the arms 24, 26 and the central portion 20 lie in the first surface plane 15. Opposite the first surface plane 15 is a bottom surface plane 17. The distance between the first upper surface plane 15 and bottom surface plane 17 generally defines the module height (H1), which may be about 0.20 mm or more, such as from about 0.20 to about 3.0 mm, and such as from about 0.40 to about 2.0 mm and such as from about 0.50 to about 1.50 mm, such as from about 0.60 to about 1.00 mm.

The first and second ends 30, 32 may be U-shaped, such as illustrated in FIGS. 2 and 3, with the interior peripheral edge of the U-shaped portion defining openings 28a, 28b. The openings 28a, 28b generally extend continuously through each of the opposite extending arms 24, 26 to form an opening throughout the width dimension of the module 10. Further, the openings 28a, 28b may be disposed along a first and a second transverse axis 14, 16, which may be arranged parallel to the cross-machine direction. In this manner the openings 28a, 28b may form a housing in the opposite extending arms 24, 26 for receiving a linkage pin extending in the cross-machine direction so that the discrete modules may be pivotally interconnected with one another.

To lend stability to the module, particularly to resist z-directional compression forces commonly encountered in the papermaking process, the module may be provided with a one or more pillars oriented in the z-direction and extending from a first interior peripheral surface of the module to a second interior peripheral surface. For example, as illustrated in FIGS. 2 and 3, the module 10 may be provided with first and second pillars 27a, 27b, which extend from a lower interior peripheral surface to an upper peripheral surface and are integrally formed with the module. The pillar is generally oriented orthogonal to the machine direction and may have a width approximately equal to the width of the arm, or may have a width that is less than the width of the arm. In the illustrated embodiment, the pillars 27a, 27b are generally disposed along the central portion 20 and extend in the cross-machine direction such that their width is approximately equal to the width to the arm. The pillars 27a, 27b are spaced apart from one another to define an opening 29 there between. While the pillars are illustrated as being disposed substantially along the central portion, the invention is not so limited and the pillars may be positioned along the central portion of the arms to provide the desired level of stability.

With continued reference to FIGS. 2 and 3, the module 10 further comprises a pair of protuberances 40a, 40b extending above the first upper surface plane 15 and defining a second upper surface plane 43. The protuberances 40, which are preferably integrally formed with the remainder of the module body, have a top surface 41 lying in a second surface plane 43. In this manner the web contacting surface of the resulting belt may comprise the upper surface of the module body and the upper surface of the protuberances to provide the web contacting surface with two principle planes lying in two different elevations.

A pair of opposed sidewalls 45, 47 join the top surface 41 resulting in the illustrated protuberances 40a, 40b having a height (h) and a width (w). Accordingly, in the illustrated embodiment, the protuberances 40a, 40b have generally planar sidewalls 45, 47 and a square cross-sectional shape where the width (w) and height (h) are equal. In such embodiments the width and height may vary from about 0.10 to about 3.0 mm, such as from about 0.50 to about 2.00 mm, such as from about 0.75 to about 1.50 mm. The width is generally measured normal to the principal dimension of the elevation within the plane of the module at a given location. Where the protuberance has a generally square or rectangular cross-section, the width (w) is generally measured as the distance between the two planar sidewalls that form the protuberance. In those cases where the element does not have planar sidewalls, the width is measured along the base of the protuberance at the first upper surface plane of the module.

While the illustrated element has a square cross-section, the invention is not so limited. The protuberances may have any number of rectilinear or curvilinear cross-sectional shapes such as, for example, rectangular, trapezoidal, triangular, convex, or concave. For example, the elements may comprise generally planar bottom and top surfaces joined by sidewalls that converge towards one another as they extend from the bottom to the top surface, resulting in an element having a trapezoidal cross-sectional shape.

Further, a single module or the resulting belt may comprise protuberances having the same or different cross-sectional shapes. A particularly preferred protuberance is substantially square shaped having sidewalls that are generally perpendicular to the first upper surface plane of the module. Alternatively, the protuberances may have a tapered lateral cross-section formed by sides that converge to yield a protuberance having a base that is wider than the distal end.

In the illustrated embodiments the protuberances are substantially solid, however, in other embodiments the protuberances may comprise an aperture. For example, the aperture may comprise a first hole disposed on the top surface of the protuberance and a second hole is disposed on the bottom surface and a continuous channel extending through the protuberance creating a continuous passageway between the first and second holes. Preferably the continuous channel and holes are shaped so as to permit the passage of air and/or water through the protuberance. To achieve the desired permeability the cross-sectional shape and size may be varied, for example, the cross-sectional shape may be circular, oval, square, rectangular, or triangular.

In other embodiments, protuberances may comprise one or more apertures disposed along one or both of the sidewalls. Like the apertures disposed along the top surface of the protuberance, and discussed above, the sidewall aperture may have any number of different cross-section shapes, including a rectangular cross-section. The sidewall aperture may comprise a first hole disposed along one of the sidewalls that is connected by a continuous channel to a second hole disposed on the bottom surface the protuberance. In this manner a continuous channel may join the sidewall hole and the bottom surface hole creating a continuous passageway between the sidewall and the bottom of the protuberance. In this manner, as the web is molded around the protuberance during manufacture water may pass from the web in contact with the sidewall, through the element and exit the bottom. Without being bound by any particular theory it is believed that this additional passageway for water enhances drying and improves molding of the embryonic web.

The protuberances may be disposed on the central portion or on one or more arms. For example, as illustrated in FIGS. 1-5 each module 10 comprises a first and second protuberance 40a, 40b disposed substantially on the first and second arms 24, 26. In other embodiments the protuberances are disposed substantially on the central portion or alternatively on one or more arms and on the central portion. The protuberances may be disposed on the module in such a manner as to create a pattern when the belt is assembled or may be disposed randomly. The protuberances may be disposed on the plurality of modules forming a belt in an identical fashion or may be disposed in a random fashion.

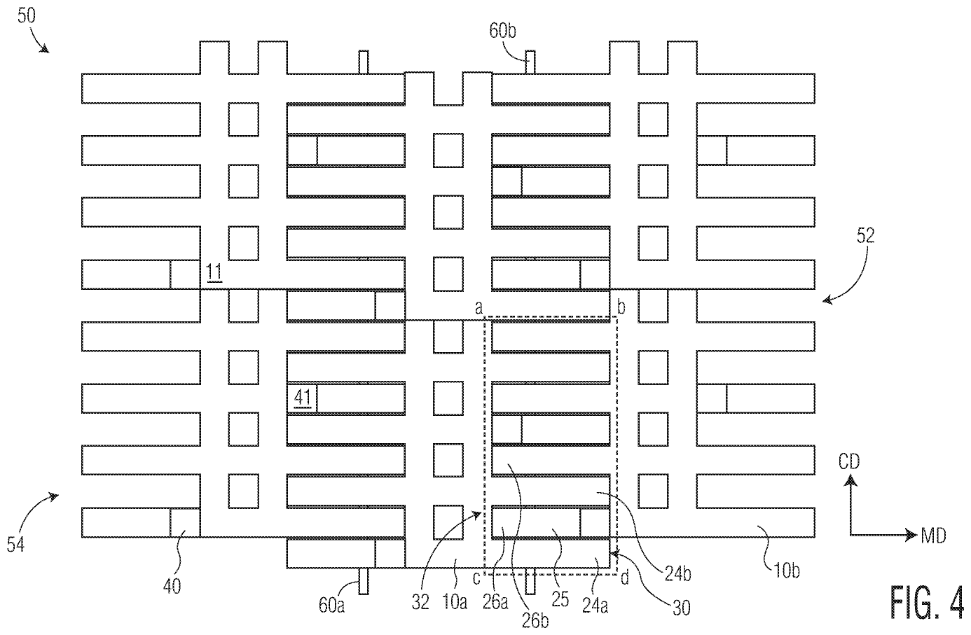

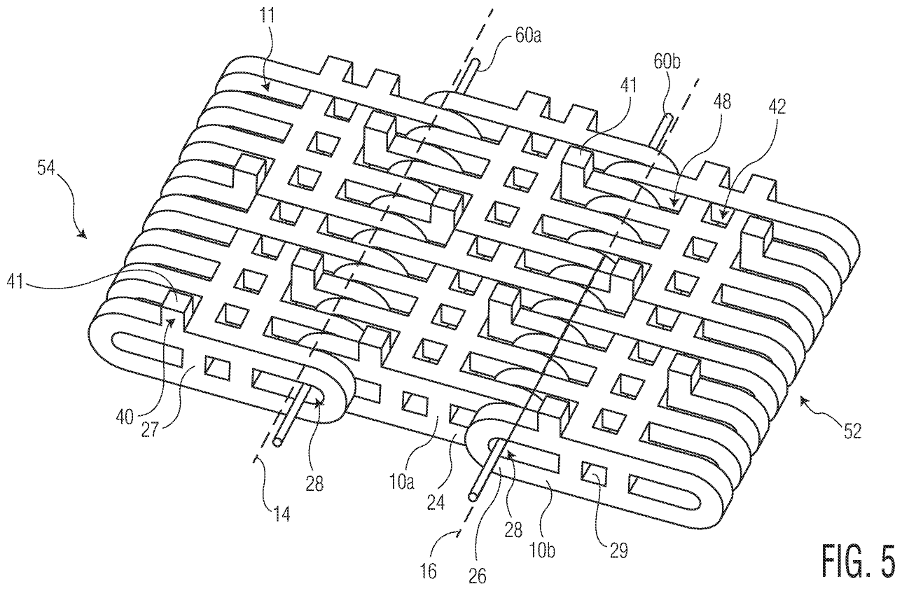

With reference now to FIGS. 4 and 5, the first linking end 30 of a first module 10a may be joined with the second linking end 32 of a second module 10b to a belt 50 according to the present invention. When completed the belt 50 may comprise first and second ends 52, 54 that may be joined together to form an endless belt useful in the manufacture of tissue products.

The construction of the belt 50 from a plurality of modules 10 will now be described with reference to FIG. 4, particularly the portion of the belt 50 outlined by box abcd. A first and second module 10a, 10b are interdigitated with one another by interdigitating arms 24 of module 10a, which form a first link end 30, with arms 26 of module 10b, which form a second link end 32. Arms 24a, 24b define an opening 25, which receive arms 26a, 26b. A linkage pin 60b joins modules 10a and 10b together. In this manner adjacent modules are interdigitated and connected by a linkage pin to form a belt of the present invention.

When assembled, the belt 50 comprises a plurality of apertures 48 disposed between the adjacent joined together modules 10, referred to herein as inter-module apertures, in addition to apertures 40 formed within a given module 10, referred to herein as intra-module apertures. The inter-module apertures 48 may be formed when the belt 50 is placed under tension in the machine direction and the interdigitated arms 24, 26 separate from one another. In certain embodiments the arms and the transverse opening for receiving the linkage pin may be designed such that the plurality of inter-module apertures are approximately the same size as the intra-module apertures. The presence of both intra-module apertures and inter-module apertures increases the overall open area of the resulting belt to improve air flow therethrough and drying of the embryonic web. In certain embodiments the resulting belt may comprise intra-module apertures and inter-module apertures and have a total open area of at least about 10 percent, and more preferably at least about 15 percent, such as from about 10 to about 30 percent and more preferably from about 15 to about 20 percent.

To form the belt 50 the interdigitated arms 24, 26 are provided with a transverse aperture 28 extending across the width of each of the arms that may receive a transversely disposed linkage pin 60. In this manner the linking portion of two adjacent modules includes a plurality of spaced apart parallel arms extending along the axis substantially parallel to the machine direction of the belt and constructed for interdigitating with the arms of an adjacent module. For example, with reference to FIG. 5, arms 24 forming a first linking end and opposite extending arms 26 forming a second linking end are interdigitated and a linkage pin 60b is inserted in the transverse aperture 28 to join modules 10a and 10b together. In this manner the modules are joined together so as to extend in both the cross-machine and machine directions of the belt and the first and second ends are hinged for pivotal movement about a pin.

The linkage pins are preferably constructed from polymeric materials and have a head and a latching end portion for retention of the pin in the modules. The linkage pins may comprise a polymeric monofilament having a substantially circular cross-sectional shape. In other embodiments the pin may comprise a resin-treated polyamide, such as a polyamide monofilament impregnated phenolic or epoxy polymer resins. In still other embodiments the linkage pin may comprise polyamide multi-filaments wrapped around a polyamide monofilament core.

Generally the linkage pin extends across the entirety of the cross-direction dimension of the belt. The pin diameter is generally chosen to be as large as will easily be accommodated by the openings in the module ends and in certain instances may be optimized to lend stability to the belt.

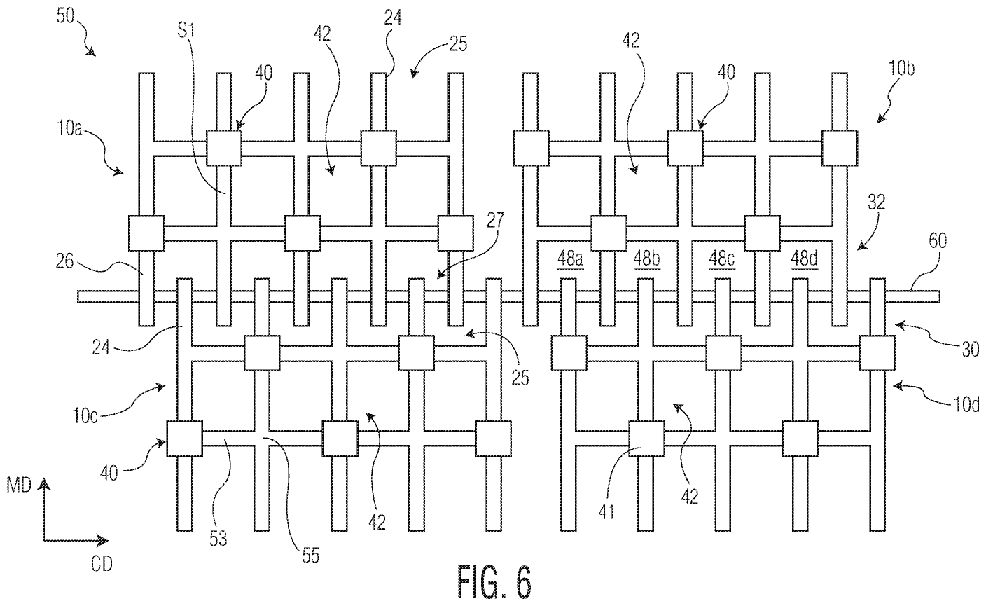

In other embodiments, such as that illustrated in FIG. 6, the belt 50 comprises a plurality of modules 10a-10c, where each module comprises a grid-like lattice of machine and cross-machine direction oriented module elements 51, 53. The machine direction elements 51 extend to form a plurality of first and second arms 24, 26. Machine and cross-machine direction oriented module elements 51, 53 intersect to define a plurality of land areas 55 and a plurality of centrally disposed apertures 42. Further, a plurality of protuberances 40 are disposed at several of the land areas 55 formed by the intersection of the machine and cross-machine direction oriented module elements 51, 53. The protuberances 40 may be disposed on the land areas 55 in such a manner that when a plurality of modules 10 are combined to form a belt 50 the protuberances 40 form a pattern.

Arms 24, 26 include a plurality of spaced openings 25, 27 which are shaped to cooperate with the arms of an adjacent module. When the arms 24, 26 are interdigitated and joined by a linkage pin 60, the resulting belt 50 may be tensioned to create a plurality of apertures 48a-48d between interdigitated modules, such as modules 10b and 10d. In certain embodiments the arms 24, 26 and the transverse opening for receiving the linkage pin 60 may be designed such that the plurality of inter-module apertures 48a-48d are approximately the same size as the intra-module apertures 42. The presence of both intra-module apertures and inter-module apertures increases the overall open area of the resulting belt to improve air flow therethrough and drying of the embryonic web. In certain embodiments the resulting belt may comprise intra-module apertures and inter-module apertures and have a total open area of at least about 10 percent, and more preferably at least about 15 percent, such as from about 10 to about 30 percent and more preferably from about 15 to about 20 percent.

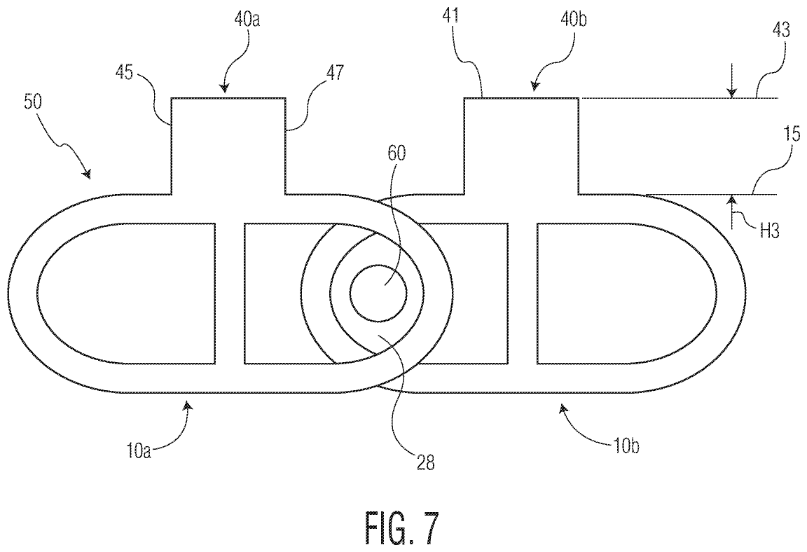

In still other embodiments, such as that illustrated in FIG. 7, individual modules 10a, 10b may be interdigitated and joined by a linkage pin 60 disposed in aperture 28 extending through the interdigitated modules 10a, 10b to form a belt 50. Each module 10a, 10b may comprise only a single protuberance 40a, 40b disposed substantially along the module midpoint (relative to the machine direction axis of the module) and extending upward from the module surface 11. In this manner the protuberances 40a, 40b have a height (H3) generally defined as the distance between the module surface plane 15 and the protuberance upper surface plane 43.

In a particularly preferred embodiment the protuberances are discrete and in certain embodiments may be arranged to create a decorative pattern. For example, the protuberances may be spaced and arranged in a non-random pattern so as to create a wave-like decorative pattern when the modules are assembled to form a belt according to the present invention. As a result of the spacing and arrangement of decorative patterns, landing areas are created between adjacent patterns. The landing areas provide a visually distinctive interruption to the decorative pattern formed by the individual spaced apart protuberances. In this manner, despite being discrete elements, the protuberances may be spaced apart so as to form a visually distinctive curvilinear decorative pattern that extends substantially in the machine direction. Thus, in certain embodiments, taken as a whole the discrete elements form a wave-like decorative pattern. The wave-like decorative pattern may have dimensions similar to those described above for line elements forming wave-like patterns, such as an amplitude from about 10 to about 40 mm and a wavelength from about 50 to about 200 mm. Further the individual wave-like patterns may be spaced apart from one another from about 1.0 to about 20 mm apart and more preferably from about 2.0 to about 10 mm apart.

In other embodiments the protuberances may be spaced and arranged so as to form a decorative figure, icon or shape such as a flower, heart, puppy, logo, trademark, word(s), and the like. Generally the design elements are spaced about the support structure and can be equally spaced or may be varied such that the density and the spacing distance may be varied amongst the design elements. For example, the density of the design elements can be varied to provide a relatively large or relatively small number of design elements on the web. In a particularly preferred embodiment the design element density, measured as the percentage of background surface covered by a design element, is from about 10 to about 35 percent and more preferably from about 20 to about 30 percent. Similarly the spacing of the design elements can also be varied, for example, the design elements can be arranged in spaced apart rows. In addition, the distance between spaced apart rows and/or between the design elements within a single row can also be varied.

The size of the protuberances and the spacing between adjacent protuberances may be the same throughout a given design or an entire belt or it may be varied throughout a design or the entire belt. For example, a design may be formed by protuberances having two, three, four or five different sizes where the space between the protuberances varies depending on the relative size of the adjacent protuberances. Thus, in certain embodiments the ratio of the surface area of protuberances and the width of the spaces may range from about 5:1 to about 1:2, such as from about 4:1 to about 1:1.

While the protuberances may be spaced and arranged so as to form a decorative pattern, adjacent protuberances are generally spaced apart from one another so as to create spaces there between. Depending upon the arrangement and spacing of individual protuberances relative to one another the inter-protuberance spaces may or may not include apertures or voids that are permeable to air and liquid. In certain embodiments the inter-protuberance spaces may be entirely devoid of material to form the module and in other embodiments the inter-protuberance space may include an aperture portion of the module.

The spaced apart protuberances form landing areas there between, which together with the elements generally make up the web contacting surface of the belt. In use, as the embryonic tissue web is formed fibers are deflected in the z-direction by the continuous elements, however, the spacing of elements is such that the web maintains a relatively uniform density. This arrangement provides the benefits of improved web extensibility, increased sheet bulk, better softness, and a more pleasing texture. These properties may be influenced by varying the percentage of elements constituting the web contacting surface. For example, in certain embodiments, the spacing and arrangement may be adjusted such that the elements constitute greater than about 15 percent of the web contacting surface, such as from about 15 to about 35 percent, more preferably from about 18 to about 30 percent, and still more preferably from about 20 to about 25 percent of the web contacting surface.

An additional means of altering the physical properties of manufactured webs, such as caliper, density and cross-machine direction stretch and toughness, is to alter the shape of the element and particularly the shape of line elements, as well as the spacing and arrangement of line elements relative to one another. For example, the line element may have a wave-like pattern where the line elements are arranged in-phase with one another such that P (the distance between adjacent elements measured from the center of one element to the center of the adjacent element) is approximately constant. In other embodiments elements may form a wave pattern where adjacent elements are offset from one another. In still other embodiments the line elements may be linear. In other embodiments the elements may be linear and form a pattern having adjacent linear elements that alternate between a maximum spacing when the line elements diverge away from each other and minimum spacing when the line elements converge toward each other. In a particularly preferred embodiment, regardless of the particular element pattern, or whether adjacent patterns are in or out of phase with one another, the elements are separated from one another by some minimal distance.

In other embodiments the protuberances are discrete and disposed on the modules such that they form a continuous pattern having a sinusoidal shape. The discrete protuberances are further arranged so as to define a plurality of sinusoidal shaped elements that are substantially parallel to one another such that none of the elements intersect one-another. As such, individual design elements forming the pattern are equally spaced apart from one another. In such embodiments, the center-to-center spacing of design elements (also referred to herein as pitch or simply as p) may be greater than about 1.0 mm, such as from about 1.0 to about 20 mm apart and more preferably from about 2.0 to about 10 mm apart. In one particularly preferred embodiment the continuous elements are spaced apart from one-another from about 3.8 to about 4.4 mm.

Where the protuberances are arranged so as to provide a pattern comprising elements having a wave-like shape the design elements may have an amplitude (A) and a wavelength (L). The amplitude may range from about 2.0 to about 200 mm, in a particularly preferred embodiment from about 10 to about 40 mm and still more preferably from about 18 to about 22 mm. Similarly, the wavelength may range from about 20 to about 500 mm, in a particularly preferred embodiment from about 50 to about 200 mm and still more preferably from about 80 to about 120 mm.

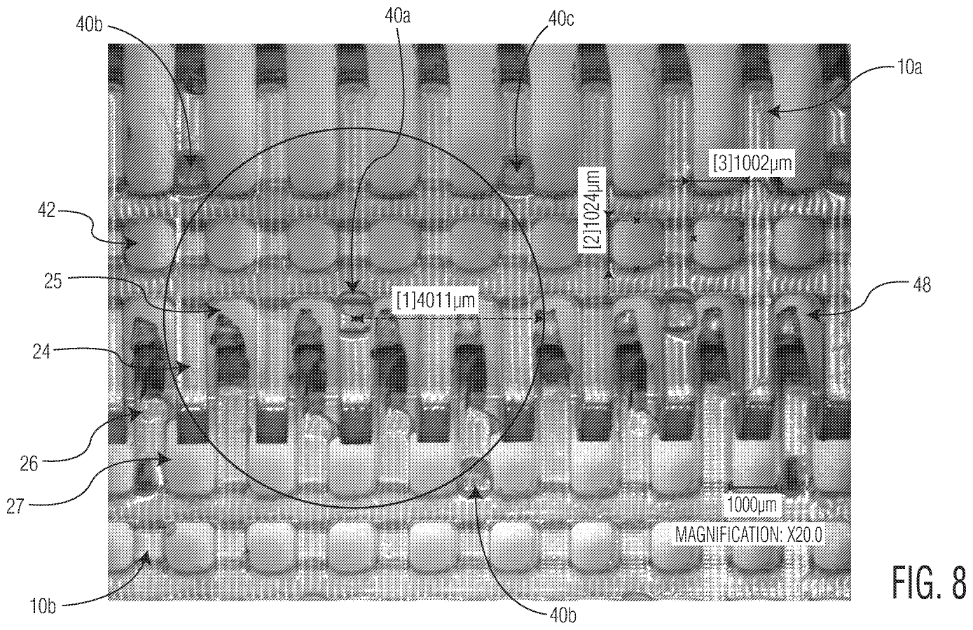

With reference now to FIG. 8 first and second arms 24, 26 of first and second modules 10a, 10b, may be interdigitated and joined by a linkage pin 60 to form a belt 50. The resulting belt 50 comprises intra-module apertures 42 and inter-module 48 apertures formed by a portion of the openings 25, 27. The belt further comprises a plurality of protuberances 40a-40c, where the protuberances are spaced apart from one another to define landing areas there between. The landing areas are formed from both a portion of the module itself and a portion of interdigitated modules. In the illustrated embodiments the plurality of protuberances 40a-40c have a generally square cross-sectional shape and are uniformly spaced apart from one another so as to define similarly sized landing areas. As illustrated, the plurality of protuberances 40a-40c are spaced apart from one another a radial distance of about 4,000μ.

Each of the modules are of integral construction and are preferably manufactured by 3-D printing. Useful 3-D printing techniques include, for example, continuous liquid interphase printing (CLIP), fused deposition modeling (FDM), electron-beam freeform fabrication (EBF3), direct metal laser sintering (DMLS), electron-beam melting (EBM), selective laser sintering (SLS), selective heat sintering (SHS), laminated object manufacturing (LOM), stereolithography (SLA), digital light processing (DLP), and multi-jet modeling (MJM). Particularly preferred 3-D printing techniques include SLA, such as that disclosed in U.S. Pat. No. 5,236,637, SLS, such as that disclosed in U.S. Pat. No. 5,639,070 and CLIP, such as that disclosed in U.S. Pat. No. 9,216,546.

Three-dimensional printing of the modules generally begins with creating a computer model of the element in three dimensions using a suitable computer modeling program known in the art. The computer model of the element is completely sectioned into a series of horizontal digital slices to define a set of slice patterns for each layer.

Suitable materials for forming modules by 3-D printing include photo-curable and self-curing polymeric materials. Photo-curable polymeric materials may include resins curable by UV curing, visible light curing, electron beam curing, gamma radiation curing, radiofrequency curing, microwave curing, infrared curing, or other known curing methods involving application of radiation to cure a polymeric material. Suitable polymeric materials may also include those that may be cured via chemical reaction without the need for added radiation as in the extrusion of an autocuring polymer such as polyurethane mixtures, thermal curing, solidifying of an applied hotmelt or molten thermoplastic.

In certain embodiments the polymeric material may comprise a first component selected from the group consisting of a photo-curable group, a peroxide curable group, an EB curable group, and a cationic curable group. Preferably the first component is selected from the group consisting of vinyl, acrylate, methacrylate, and acrylonitrile. The polymeric material further comprises a second component selected from the group consisting of a cyanate ester, isocyanate, Benzoxazine, polyimide, Bismaleimide, Phthalonitrile resin (PN), Bismaleimide-Triazine (BT), epoxy, silicone resins, epoxy-cyanate, and mixtures thereof.

In other embodiments the polymeric material may comprise PET (polyester), PPS (polyphenylene sulphide), PCTA (poly 1,4 cyclohexane dimethylene terephthalate), PEN (polyethylene naphthalate), PVDF (polyvinylidene fluoride) or PEEK (polyetheretherketone), either alone or in combination.

In still other embodiments the polymeric material comprises a thermoplastic such as, for example, a thermoplastic comprising from about 0.5 and 10 weight percent silicone and a base polymer selected from the group consisting of polyethersulfones, polyetherimides, polyphenylsulfones, polyphenylenes, polycarbonates, high-impact polystyrenes, polysulfones, polystyrenes, acrylics, amorphous polyamides, polyesters, nylons, PEEK, PEAK and ABS.

In other embodiments a conducting material may be printed in addition to the polymeric material used to form the modules. The conducting material may be printed as thermally conductive layers or deposits within the polymeric material forming the module. The heat conducting material may be provided as an ink filled with one or more carbon-based materials, such as carbon nanotubes, grapheme and carbon black. In other embodiments the conductive material may comprise one or more metals, such as silver, copper, and titanium, or any other suitable metal. As a further alternative, the heat conducting material may comprise an ink filled with ceramic particles. Suitable ceramic particles may include ceramic micron sized, sub-micron and/or nano-particles, such as ceramic nano-tubes, and ceramic sub-micron particles. Particle sizes of the thermally conductive materials are preferably small enough to facilitate printing, such as less than about than 5 microns.

### Test Methods

Projected area and projected open area was measured by first generating a digital image of the fabric contacting surface of a sample using an FRT MicroSpy Profile profilometer (FRT of America, LLC, San Jose, Calif.) and then analyzing the image using Nanovea Ultra software version 6.2 (Nanovea Inc., Irvine, Calif.). Samples measuring approximately 145×145 mm were analyzed. The samples were secured to the x-y stage of the profilometer using tape, with the fabric contacting surface of the sample facing upwards, being sure that the samples were laid flat on the stage and not distorted within the profilometer field of view.

Once the sample was secured to the stage the profilometer was used to generate a three-dimension height map of the sample surface. A 1602×1602 array of height values were obtained with a 30 Jim spacing resulting in a 48 mm MD×48 mm CD field of view having a vertical resolution of 100 nm and a lateral resolution of 6 μm. The resulting height map was exported to .sdf (surface data file) format. Individual sample .sdf files were analyzed using Nanovea Ultra version 6.2 by performing the following functions:

(1) Using the “Thresholding” function of the Nanovea Ultra software the raw image (also referred to as the field) is subjected to thresholding by setting the material ratio values at 0.5 to 99.5 percent such that thresholding truncates the measured heights to between the 0.5 percentile height and the 99.5 percentile height; and

(2) Using the “Fill In Non-Measured Points” function of the Nanovea Ultra software the non-measured points are filled by a smooth shape calculated from neighboring points;

Based upon the foregoing, three values, indicative of surface smoothness are reported: Spar (Projected Surface Area) and Sdar (Developed Area), which all have units of mm. The units have been converted to microns for use herein.

### Embodiments

Having now described the present invention with references to the attached figures, it will be appreciated that in a first embodiment the present invention provides a papermaking belt having a machine direction axis, a cross-machine direction axis orthogonal to the machine direction axis, a first web contacting surface and an opposed machine contacting surface, the belt comprising a plurality of discrete modules, each module having a first side and an opposite second side, the first side comprising a plurality of protuberances, the module further comprising a plurality of apertures extending from the first side to the second side and a first plurality of arms extending in a first direction and a second plurality of arms extending in a second direction opposite the first direction, the first and second plurality of arms extending along an axis substantially parallel to the machine direction of the belt, the first plurality of arms of a first module interdigitated with the second plurality of arms of a second module, the interdigitated arms having a linkage pin disposed therein.

In a second embodiment the present invention provides the papermaking belt of the first embodiment wherein the plurality of modules are formed layer by layer, in a stepwise fashion, out of a flowable polymeric material selected from the group consisting of a cyanate ester, isocyanate, Benzoxazine, polyimide, Bismaleimide, Phthalonitrile resin (PN), Bismaleimide-Triazine (BT), epoxy, silicone resins, epoxy-cyanate, and mixtures thereof.

In a third embodiment the present invention provides the papermaking belt of the first or the second embodiment wherein the plurality of protuberances are discrete and uniformly spaced apart from one another. In certain embodiments the uniformly spaced apart protuberances may be spaced apart from one another a radial distance of at least about 2.0 mm and more preferably at least about 4.0 mm, such as from about 2.0 to about 6.0 mm.

In a fourth embodiment the present invention provides the papermaking belt of the first through the third embodiments wherein the protuberances have a height from about 0.1 to about 3.0 mm.

In a fifth embodiment the present invention provides the papermaking belt of the first through the fourth embodiments wherein the protuberances have a cross-sectional shape selected from the group consisting of round, oval, triangular, square, rectangular, pentagonal, hexagonal and octagonal.

In a sixth embodiment the present invention provides the papermaking belt of the first through the fifth embodiments wherein the belt has a projected open area from about 4.0 to about 25 percent.

In a seventh embodiment the present invention provides the papermaking belt of the sixth embodiment wherein the web contacting surface of the belt has a projected open area from about 1.0 to about 20 percent.

In an eighth embodiment the present invention provides the papermaking belt of the first through the seventh embodiments wherein the apertures comprise intra-module apertures and inter-module apertures. In certain embodiments the intra-module apertures and inter-module apertures have substantially similar dimensions.

We claim:

1. A papermaking belt having a machine direction axis, a cross-machine direction axis orthogonal to the machine direction axis, a first web contacting surface and an opposed machine contacting surface, the belt comprising a plurality of discrete modules, each module having a first side and an opposite second side, the first side comprising a plurality of protuberances, the module further comprising a plurality of apertures extending from the first side to the second side and a first plurality of arms extending in a first direction and a second plurality of arms extending in a second direction opposite the first direction, the first and second plurality of arms extending along an axis substantially parallel to the machine direction of the belt, the first plurality of arms of a first module interdigitated with the second plurality of arms of a second module, the interdigitated arms having a linkage pin disposed therein.

2. The belt of claim 1 wherein the modules are manufactured by a 3-D printing process selected from the group consisting of continuous liquid interphase printing (CLIP), fused deposition modeling (FDM), electron-beam freeform fabrication (EBF3), direct metal laser sintering (DMLS), electron-beam melting (EBM), selective laser sintering (SLS), selective heat sintering (SHS), laminated object manufacturing (LOM), stereolithography (SLA), digital light processing (DLP), and multi-jet modeling (MJM).

3. The belt of claim 2 wherein the modules and protuberances comprise the same material and the material is selected from the group consisting of a cyanate ester, isocyanate, Benzoxazine, polyimide, Bismaleimide, Phthalonitrile resin (PN), Bismaleimide-Triazine (BT), epoxy, silicone resins, epoxy-cyanate, and mixtures thereof.

4. The belt of claim 1 wherein the web contacting surface has a projected open area from about 10 to about 30 percent.

5. The belt of claim 4 wherein the projected open area of the machine contacting surface is substantially similar to the projected open area of the web contacting surface.

6. The belt of claim 1 wherein the web contacting surface has a projected open area from about 4.0 to about 25 percent.

7. The belt of claim 1 wherein the machine contacting surface is substantially smooth.

8. The belt of claim 1 having an air permeability greater than about 50 cubic feet per minute (CFM).

9. The belt of claim 1 having an air permeability from about 300 to about 1,000 CFM.

10. The belt of claim 1 wherein the protuberances are discrete and have a height from about 0.5 to about 3.5 mm and a width from about 0.5 to about 3.5 mm.

11. The belt of claim 8 wherein the protuberances have substantially similar heights and widths.

12. The belt of claim 11 wherein the protuberances have a cross-sectional area from about 0.20 to about 3.0 mm².

13. The belt of claim 11 wherein the protuberances have a substantially identical cross-sectional shape selected from the group consisting of round, oval, triangular, square, rectangular, pentagonal, hexagonal and octagonal.

14. The belt of claim 1 wherein the apertures have a cross-sectional area from about 0.60 to about 1.00 mm².

15. The belt of claim 14 wherein the apertures have a cross-sectional shape selected from the group consisting of round, oval, triangular, square, rectangular, pentagonal, hexagonal and octagonal.

16. A papermaking belt having a machine direction axis and a cross-machine direction axis orthogonal to the machine direction axis, the belt comprising:
a. a plurality of discrete modules comprising a first side and an opposite second side, the first side comprising a plurality of protuberances, a first plurality of arms extending in a first direction and a second plurality of arms extending in a second direction opposite the first direction, the first and second plurality of arms extending along an axis substantially parallel to the machine direction of the belt, the first plurality of arms of a first module interdigitated with the second plurality of arms of a second module;
b. a linkage pin disposed in the interdigitated arms of the discrete modules;
c. a plurality of intra-module apertures;
d. a plurality of inter-module apertures;
e. a web contacting surface having a first surface plane and a second surface plane, wherein the second surface plane is defined by the distal ends of the plurality of protuberances; and
f. a substantially smooth machine contacting surface opposite the web contacting surface.

17. The belt of claim 16 wherein the modules are manufactured by a 3-D printing process selected from the group consisting of continuous liquid interphase printing (CLIP), fused deposition modeling (FDM), electron-beam freeform fabrication (EBF3), direct metal laser sintering (DMLS), electron-beam melting (EBM), selective laser sintering (SLS), selective heat sintering (SHS), laminated object manufacturing (LOM), stereolithography (SLA), digital light processing (DLP), and multi-jet modeling (MJM).

18. The belt of claim 17 wherein the modules and protuberances comprise the same material and the material is selected from the group consisting of a cyanate ester, isocyanate, Benzoxazine, polyimide, Bismaleimide, Phthalonitrile resin (PN), Bismaleimide-Triazine (BT), epoxy, silicone resins, epoxy-cyanate, and mixtures thereof.

19. The belt of claim 16 wherein the web contacting surface has a projected open area from about 10 to about 30 percent.

20. The belt of claim 16 wherein the web contacting surface has a projected open area from about 4.0 to about 25 percent.

21. The belt of claim 16 wherein the plurality of protuberances are discrete protuberances separated from one another by a radial distance of at least about 0.5 mm and defining landing areas there between, the landing areas lying in the first surface plane of the web contacting surface of the belt.

22. The belt of claim 16 having an air permeability from about 300 to about 1,000 CFM.

23. The belt of claim 16 wherein the protuberances are discrete and have a height from about 0.5 to about 3.5 mm and width from about 0.5 to about 3.5 mm.

24. The belt of claim 16 wherein the protuberances have substantially similar cross-sectional shapes, heights and widths.

25. The belt of claim 16 wherein protuberances have a cross-sectional shape selected from the group consisting of round, oval, triangular, square, rectangular, pentagonal, hexagonal and octagonal and a cross-sectional area from about 0.20 to about 3.0 mm².

26. The belt of claim 16 wherein the apertures have a cross-sectional shape selected from the group consisting of round, oval, triangular, square, rectangular, pentagonal, hexagonal and octagonal and a cross-sectional area from about 0.60 to about 1.00 mm².

27. A method of manufacturing a papermaking belt comprising the steps of:
a. 3-D printing a plurality of discrete modules having a first plurality of arms extending in a first direction and a second plurality of arms extending in a second direction opposite the first direction and a plurality of intra-module apertures;
b. interdigitating the first plurality of arms of a first module with the second plurality of arms of a second module; and
c. inserting a linkage pin in the interdigital arms of the first and second modules.

28. The method of claim 27 wherein the modules comprise a material is selected from the group consisting of a cyanate ester, isocyanate, Benzoxazine, polyimide, Bismaleimide, Phthalonitrile resin (PN), Bismaleimide-Triazine (BT), epoxy, silicone resins, epoxy-cyanate, and mixtures thereof.

29. The method of claim 27 wherein the 3-D printing step is selected from the group consisting of continuous liquid interphase printing (CLIP), fused deposition modeling (FDM), electron-beam freeform fabrication (EBF3), direct metal laser sintering (DMLS), electron-beam melting (EBM), selective laser sintering (SLS), selective heat sintering (SHS), laminated object manufacturing (LOM), stereolithography (SLA), digital light processing (DLP), and multi-jet modeling (MJM).

30. The method of claim 27 wherein the plurality of intra-module apertures have a cross-sectional shape selected from the group consisting of round, oval, triangular, square, rectangular, pentagonal, hexagonal and octagonal and a cross-sectional area from about 0.60 to about 1.00 mm².

31. The method of claim 27 further comprising the steps of repeating steps (b) and (c) to produce a belt having a first end comprising a plurality of arms extending in a first direction and a second end comprising a plurality of arms extending in a second direction, interdigitating the first and second ends, and inserting a linkage pin in the interdigital arms of the first and second ends to form an endless belt.
